(19) United States
(12) Patent Application Publication
(10) Pub. No.: US 2012/0072875 A1
(43) Pub. Date: Mar. 22, 2012

(54) Composition Based Double-Patterning Mask Planning

(76) Inventors: Pradiptya Ghosh, San Jose, CA (US); Qiao Li, Wilsonville, OR (US)

(21) Appl. No.: 13/113,011

(22) Filed: May 20, 2011

Related U.S. Application Data
(60) Provisional application No. 61/346,881, filed on May 20, 2010.

(51) Int. Cl. G06F 17/50

(52) U.S. Cl. 716/52

(57) ABSTRACT

Layout design data is analyzed to identify both potential geometric element cuts in the design and instances of an application of a separation directive. Each of the identified separation directive instances and the identified cuts are assigned an analysis value, such as a weight value. The separation directive instances and the identified cuts then are ordered in a single list according to their analysis values. Each item on the list is then analyzed, to determine if the item can be implemented in the layout design data without creating a conflict in complementary pattern sets for using in a double-patterning lithographic technique. If a list item (either separation directive instance or identified cut) cannot be implemented without creating a conflict in one of the complementary patterns, then it is discarded from the list. After each of the list items has been analyzed, the remaining items are implemented in the design layout data.

### RELATED APPLICATIONS

This application claims priority under 35 U.S.C. §119 to U.S. Provisional Patent Application No. 61/346,881 entitled “Composition Based Double-Patterning Mask Planning,” filed on May 20, 2010, and naming Qiao Li and Pradiptya Ghosh as inventors, which provisional patent application is incorporated entirely herein by reference.

### FIELD OF THE INVENTION

The present invention is directed to dividing design data, such as integrated circuit layout design data, into separate sets for use with multiple lithographic masks. Various aspects of the invention may be particularly beneficial for partitioning geometric elements in a layer of layout design data into two separate groups. The two groups of data can then be used to create complementary masks for a double-patterning manufacturing process.

### BACKGROUND OF THE INVENTION

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators, and errors in the design are corrected or the design is otherwise improved.

Several steps are common to most design flows. Initially, the specification for a new circuit is transformed into a logical design, typically described in a Hardware Design Language (HDL), such as the Very high speed integrated circuit Hardware Design Language (VHDL). With this logical design, the circuit is described in terms of both the exchange of signals between hardware registers and the logical operations that are performed on those signals.

The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the desired functions. This analysis is sometimes referred to as “formal verification.”

Once the relationships between circuit devices have been established, the design is again transformed, this time into a physical design that describes specific geometric elements. This type of design often is referred to as a “layout” design. The geometric elements, which typically are polygons, define the shapes that will be created in various materials to manufacture the circuit. Typically, a designer will select groups of geometric elements representing circuit device components (e.g., contacts, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

With a layout design, each physical layer of the circuit will have a corresponding layer representation in the design, and the geometric elements described in a layer representation will define the relative locations of the circuit device components that will make up a circuit device. Thus, the geometric elements in the representation of an implant layer will define the regions where doping will occur, while the geometric elements in the representation of a metal layer will define the locations in a metal layer where conductive wires will be formed to connect the circuit devices. Typically, a designer will perform a number of analyses on the layout design. For example, the layout design may be analyzed to confirm that it accurately represents the circuit devices and their relationships as described in the device design. The layout design also may be analyzed to confirm that it complies with various design requirements, such as minimum spacings between geometric elements. Still further, the layout design may be modified to include the use of redundant geometric elements or the addition of corrective features to various geometric elements, to counteract limitations in the manufacturing process, etc.

After the layout design has been finalized, it is converted into a format that can be employed by a mask or reticle writing tool to create a mask or reticle for use in a photolithographic manufacturing process. For example, larger geometric elements in the layout design, or geometric elements that are not right triangles, rectangles or trapezoids (which typically are a majority of the geometric elements in a layout design), typically must be “fractured” into smaller, more basic polygons that can be written by the mask or reticle writing tool. This process sometimes is referred to as “fracturing” or “mask data preparation.” Once a layout design has been fractured, then the fractured layout design data can be converted to a format compatible with the mask or reticle writing tool, such as the MEBES format, the VSB11 format or the VSB12 format. The written masks or reticles then can be used in a photolithographic process to expose selected areas of a wafer to light or other radiation in order to produce the desired integrated circuit devices on the wafer.

To meet the demand for more powerful microcircuits, designers have regularly increased the average density of devices in a conventional microcircuit. For example, the area that might once have contained 100 transistors may now be required to contain 1,000 or even 10,000 transistors. Some current microcircuit designs call for microcircuit devices to be packed so closely that it may be difficult to properly manufacture adjacent device components in a single lithographic process. For example, a current microcircuit design may specify a series of parallel conductive lines positioned so closely that a conventional photolithographic process cannot resolve the pitch between the lines.

To address this issue, the structures in a layer of a microcircuit device are now sometimes formed using two or more separate lithographic processes. This technique, referred to as “double patterning,” partitions a layout design or “pattern” into two groups, each of which is then used to form a complementary lithographic mask pattern. Thus, if a layout design calls for a series of closely-spaced parallel connective lines, this original pattern may be partitioned into two complementary patterns, so that adjacent lines are actually formed by different masks in separate lithographic processes.

Because this double patterning technique typically is employed to ensure a minimum separation between adjacent structures in a microcircuit layer, the proximity relationships between the pieces of a pattern may be used to define the partition. For example, a user may create a “separation directive” that specifies when pairs of geometric element edges in the pattern must be imaged by different masks in a photolithographic process. This separation directive is then employed by a decomposition function to partition the pattern so that the resulting complementary pair of patterns conforms to the constraints given by the separation directive. Typically, this will require cutting the geometric elements (e.g., polygons) making up a pattern into segments (i.e., smaller geometric elements). It is often difficult, however, to determine how the geometric elements in the pattern should be segmented, i.e., where to cut the geometric elements.

### BRIEF SUMMARY OF THE INVENTION

Aspects of the invention relate to techniques for segmenting geometric elements in a layout design, such as a layout design for an integrated circuit or microelectromechanical system (MEMS) device. According to various implementations of the invention, the layout design data is analyzed to identify both potential geometric element cuts in the design and instances of an application of a separation directive. With various implementations of the invention, each of the identified separation directive instances and the identified cuts are assigned an analysis value, such as a weight value. The separation directive instances and the identified cuts then are ordered in a single list according to their analysis values. In some implementations of the invention, for example, the separation directive instances and the identified cuts may be ordered from most desirable to least desirable based upon their corresponding analysis values. Once the separation directive instances and the identified cuts have been combined together into a single list, the implementation of each separation directive instance and identified cut on the list can be selected by sequentially walking through the list. For example, some implementations may sequentially analyze each item on the list to determine if the item can be implemented without creating a conflict in the complementary patterns. If a list item (either separation directive instance or identified cut) cannot be implemented without creating a conflict in one of the complementary patterns, then it is discarded from the list. After each of the list items has been analyzed, the remaining items are implemented in the design. Because items in the list are analyzed in order of desirability, the most desirable items (whether separation directive instances or identified cuts) are implemented in the layout design.

### BRIEF DESCRIPTION OF THE DRAWINGS

FIG. 1 illustrates a computing system that may be used to implement various embodiments of the invention.

FIG. 2 illustrates an example of a multi-core processor unit that may be used to implement various embodiments of the invention.

FIG. 3 illustrates an example of a circuit layout design segmentation tool that may be implemented according to various embodiments of the invention.

FIGS. 4A and 4B illustrate a flowchart showing the operation of a circuit layout design segmentation tool that may be implemented according to various embodiments of the invention.

FIGS. 5A-5C illustrate examples of cut type models that can be used to determine the location of proposed cut paths according to various embodiments of the invention.

FIG. 6 illustrates an example of geometric elements that may be segmented according to various embodiments of the invention.

### DETAILED DESCRIPTION OF THE INVENTION

### Operating Environment

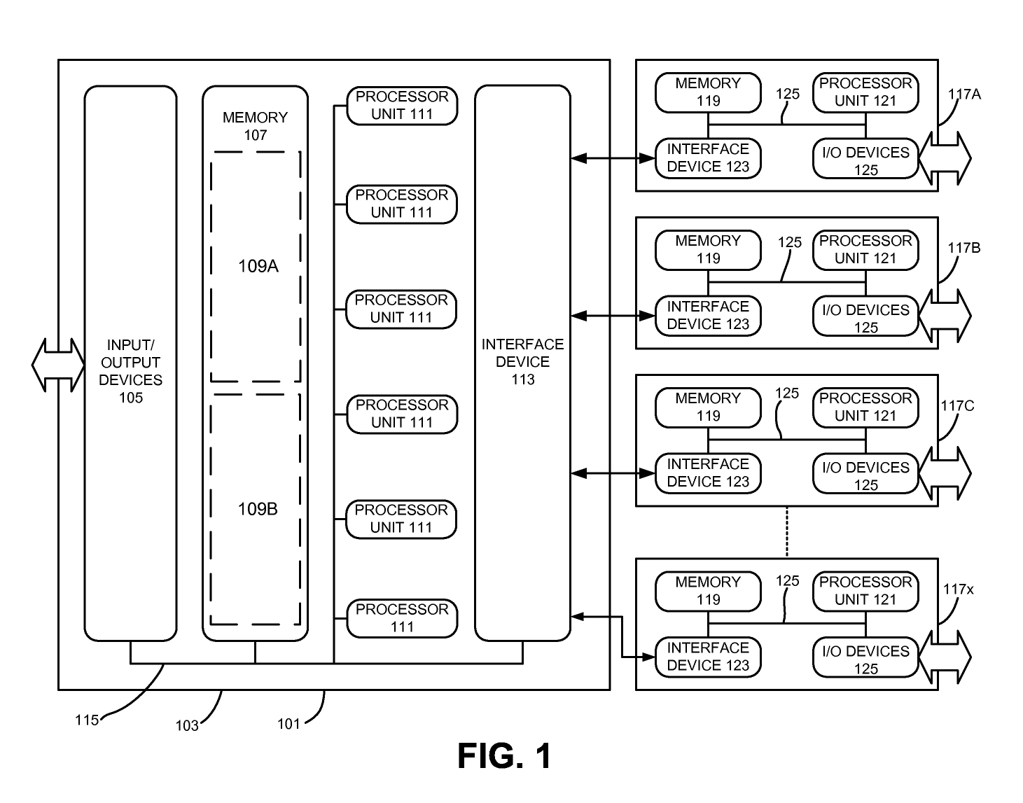

The execution of various electronic design automation processes according to embodiments of the invention may be implemented using computer-executable software instructions executed by one or more programmable computing devices. Because these embodiments of the invention may be embodied using software instructions, either stored on a tangible computer-readable medium, executing on a programmable computer, or some combination of both, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

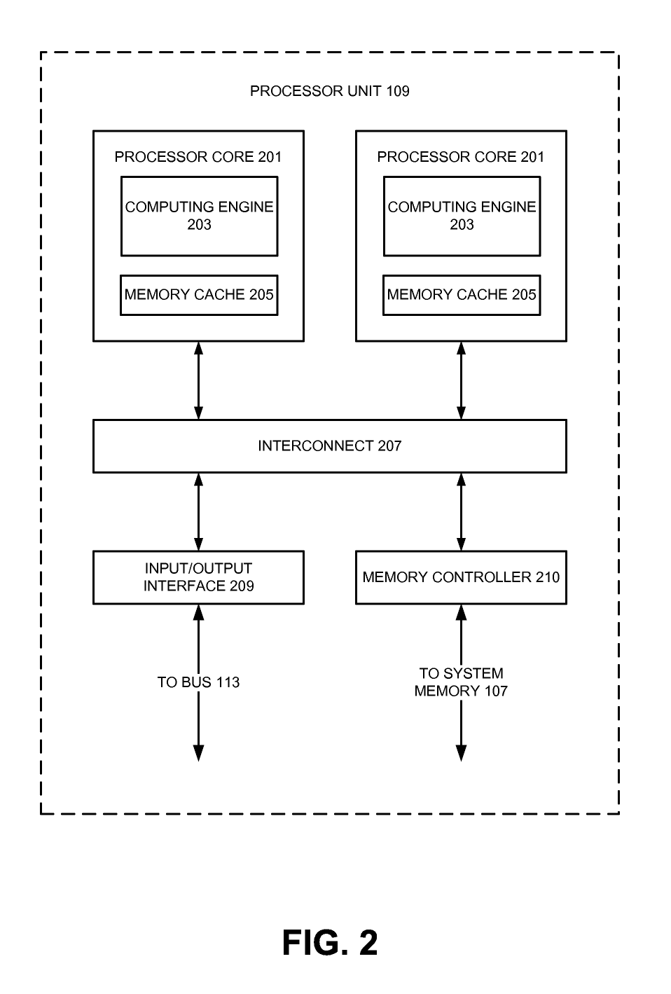

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201. While FIG. 2 shows one illustration of a processor unit 201 that may be employed by some embodiments of the invention, it should be appreciated that this illustration is representative only, and is not intended to be limiting.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in

FIG. 1 and FIG. 2 is provided as an example only, and it not intended to suggest any limitation as to the scope of use or functionality of alternate embodiments of the invention.

Organization Of Layout Design Data

As used herein, the term “design” is intended to encompass data describing an entire microdevice, such as an integrated circuit device or micro-electromechanical system (MEMS) device. This term also is intended to encompass a smaller group of data describing one or more components of an entire microdevice, however, such as a layer of an integrated circuit device, or even a portion of a layer of an integrated circuit device. Still further, the term “design” also is intended to encompass data describing more than one microdevice, such as data to be used to create a mask or reticle for simultaneously forming multiple microdevices on a single wafer. The layout design data may be in any desired format, such as, for example, the Graphic Data System II (GDSII) data format or the Open Artwork System Interchange Standard (OASIS) data format proposed by Semiconductor Equipment and Materials International (SEMI). Other formats include an open source format named Open Access, Milkyway by Synopsys, Inc., and EDDM by Mentor Graphics, Inc.

With various examples of the invention, the layout design data manipulated according to the invention will include two different types of data: “drawn layer” design data and “derived layer” design data. The drawn layer data describes geometric features that will be used to form structures in layers of material to produce the integrated circuit. The drawn layer data will usually include geometric elements, such as polygons, that represent the topographical structures to be formed in metal layers, diffusion layers, and polysilicon layers during a photolithographic process. The derived layers will then include features made up of combinations of drawn layer data and/or other derived layer data.

For example, an electronic design automation design rule check process may perform two types of operations: “check” operations that confirm whether layout design data values comply with specified parameters, and “derivation” operations that create derived layer data. Layout design data corresponding to transistor gates in a circuit design thus may be created by the following derivation operation:

gate=diff AND poly

The results of this operation will be a “derived layer” of data identifying the intersections of polygons in a drawn layer of data representing structures to be formed in a physical layer of diffusion material with polygons in a drawn layer of data representing structures to be formed in a physical layer of polysilicon material. Likewise, p-type transistor gates, formed by doping the diffusion layer with n-type material, may be identified by the following derivation operation:

pgate=nwell AND gate

The results of this operation then will be another “derived layer” of data identifying all transistor gates (i.e., intersections of diffusion layer polygons with polysilicon layer polygons) where the polygons in the diffusion layer have been doped with n-type material. With various implementations of the invention, a derived layer may include entire geometric elements, individual edges of geometric elements, portions of individual edges of geometric elements, or some combination thereof.

### Layout Design Data Segmenting Tool

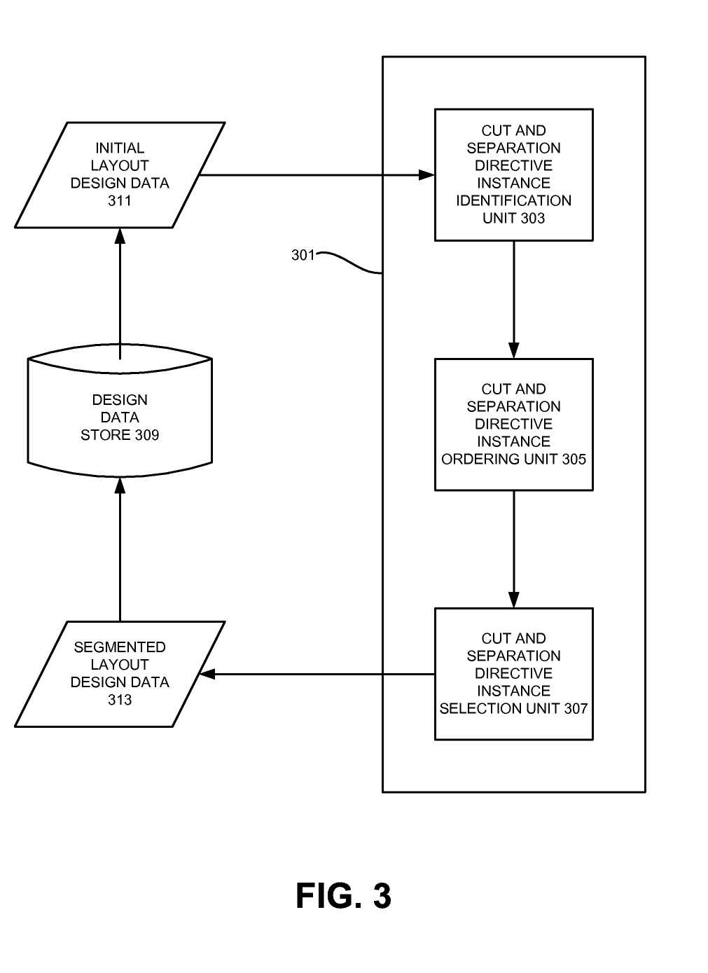

FIG. 3 illustrates an example of a layout design data segmenting tool 301 that may be implemented according to various examples of the invention. As seen in this figure, the layout design data segmenting tool 301 includes a cut and separation directive instance identification unit 303, a cut and separation directive instance ordering unit 305, and a cut and separation directive instance selection unit 307. As previously noted, various examples of the invention may be implemented by a multiprocessor computing system, such as the multiprocessor computing system 101 illustrated in FIG. 1. Accordingly, one or more components of each of the cut and separation directive instance identification unit 303, cut and separation directive instance ordering unit 305, and the cut and separation directive instance selection unit 307 may be implemented using one or more processors in a multiprocessor computing system's master computer, such as the master computer 103, one or more servant computers in a multiprocessor computing system, such as the servant computers 117, or some combination of both. It also should be appreciated that, while the cut and separation directive instance identification unit 303, cut and separation directive instance ordering unit 305, and the cut and separation directive instance selection unit 307 are shown as separate units in FIG. 3, a single servant computer (or a single processor within a master computer) may be used to implement two or more of these units at different times.

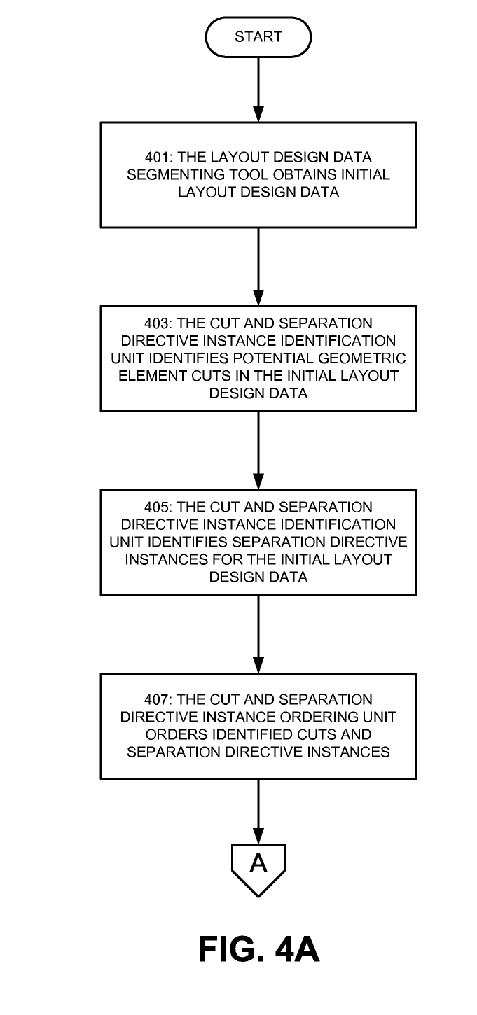

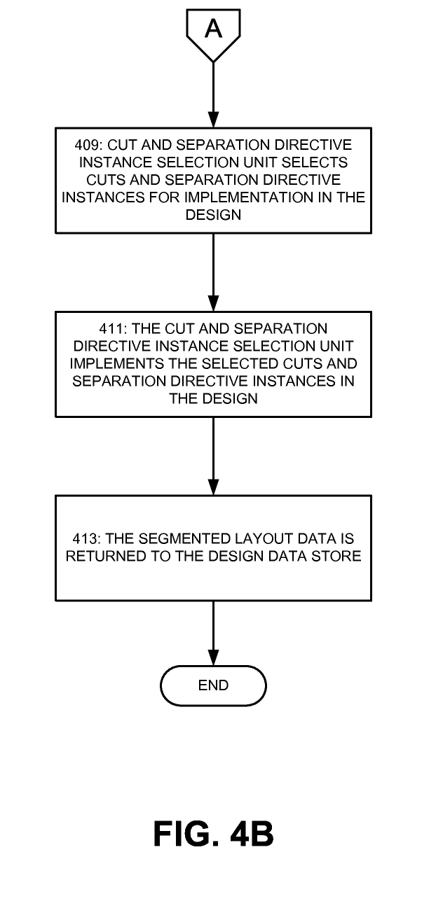

The layout design data segmenting tool 301 may work with a design data store 309. The design data store 309 may be any data storage device that is capable of storing layout design data and accessible to the layout design data segmenting tool 301. For example, the design data store 309 may be a magnetic disk drive, a rewritable optical disk drive, a “punch” type memory device, a holographic memory device, etc. Of course, while a single design data store 309 device is illustrated in FIG. 3, alternate examples of the invention may employ two or more separate memory storage devices working in concert to form the design data store 309. With various examples of the invention, the design data store 309 may store layout design data as part of a database for storing design data for use in one or more other electronic design automation processes. For example, the design data store 309 may store the layout design data as part of a hierarchical database used in conjunction with one or more physical verification or resolution enhancement technique tools, such as the family of CALIBRE® software design tools available from Mentor Graphics Corporation of Wilsonville, Oreg. It should be noted that, with various examples of the invention, the layout design data segmenting tool 301 may be implemented as part of another electronic design automation tool, such as a resolution enhancement technique tool, a layout design rule check tool, a layout design-for-manufacturability tool, etc. The operation of the layout design data decomposition tool 301 will be discussed in more detail below with regard to the flow chart illustrated in FIG. 4.

### Identification Of Potential Cuts and Separation Directive Instances

Referring now to FIG. 4, in operation 401, the layout design data segmenting tool 301 obtains initial layout design data 311. As shown in FIG. 3, the layout design data segmenting tool 301 may obtain the initial layout design data 311 from the design data store 309. With various examples of the invention, the layout design data segmenting tool 301 may receive the initial layout design data 311 from the design data store 309 either by actively retrieving the initial layout design data 311, or by being provided the initial layout design data 311 by a separate entity, such as a user, an operating system, a separate executable software program, or some combination thereof. Of course, with various examples of the invention, the initial layout design data 311 may also be obtained from a different source than the design data store 309. For example, the initial layout design data 311 may be provided to the layout design data segmenting tool 301 by a separate entity, such as a user, an operating system, a separate executable software program, or some combination thereof. Still further, the initial layout design data 311 may be obtained from a variety of sources, which may or may not include the design data store 309.

Next, in operation 403, the cut and separation directive instance identification unit 303 analyzes the initial layout design data 311 to identify potential geometric element cuts in the design. With various implementations, the cuts may be discrete, quantum cuts, extending from each of opposite edges of the geometric element. For example, with some implementations a square geometric element may be bisected by a vertical cut, bisected by a horizontal cut, or both. Any desired technique can be used to identify potential cuts. For example, with various examples of the invention, the cut and separation directive instance identification unit 303 may identify potential cuts according to a library of cut types. The parameters of the cut types indicate the type of cuts that the cut and separation directive instance identification unit 303 should identify, that is, cuts that can be made in order to segment the geometric elements of the layout in a desirable manner. The cut library may be, for example, a user-provided cut library.

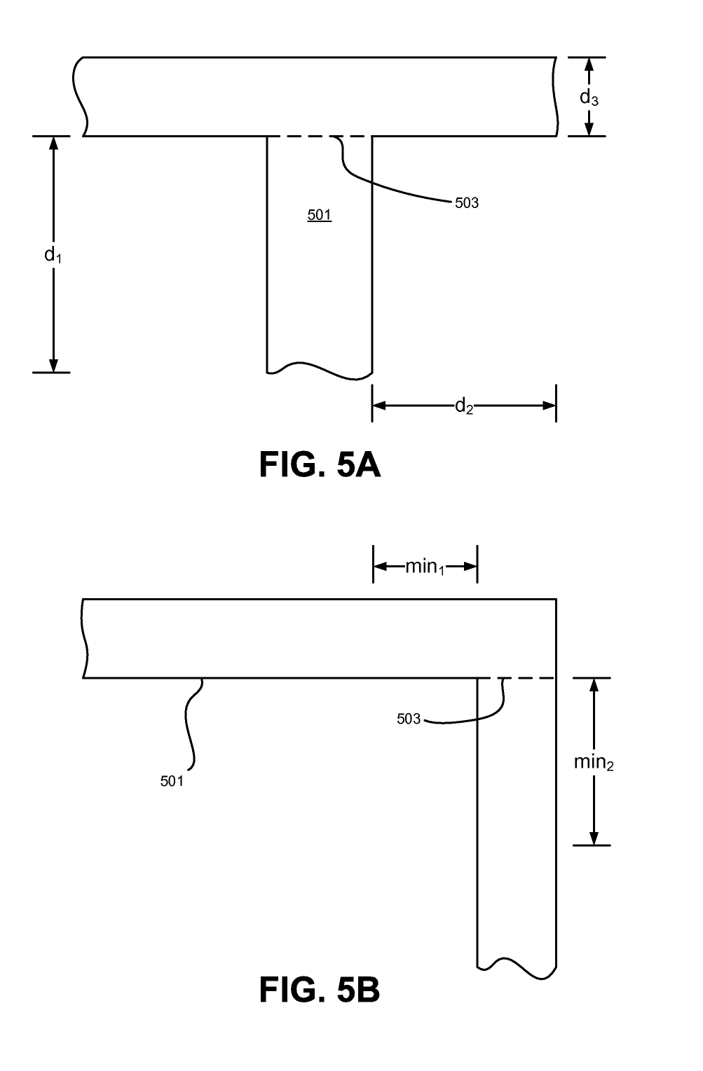

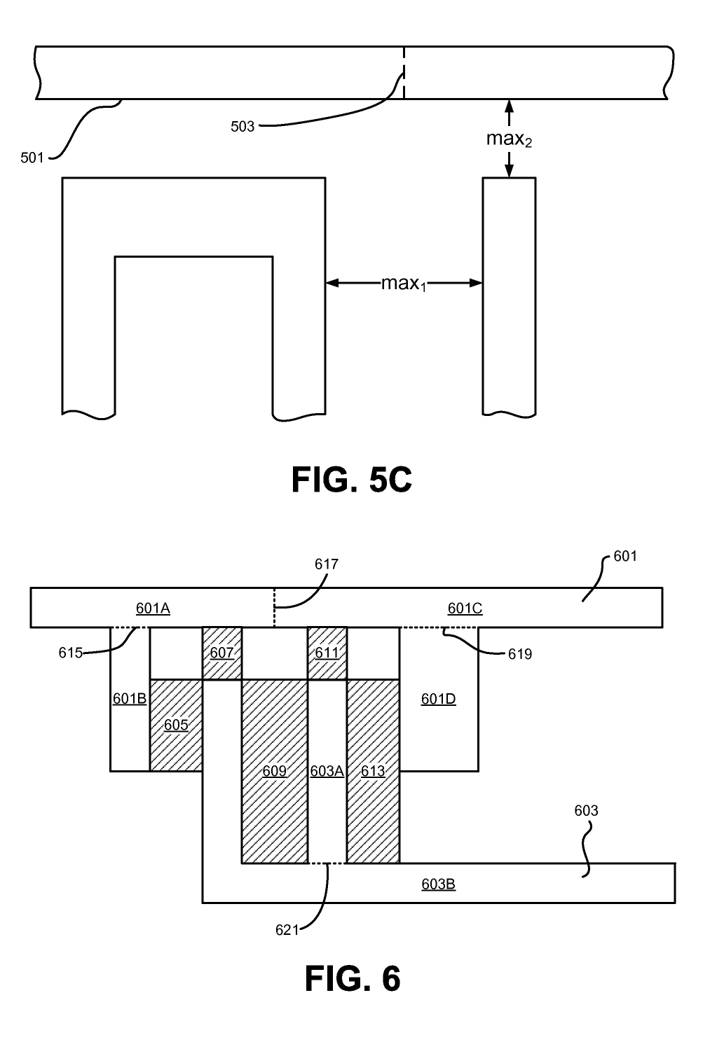

FIG. 5A illustrates one example of a cut type that may be identified according to various implementations of the invention. This cut type specifies that a geometric element 501 have a proposed cut path 503 at a local “T-shaped” intersection. With this example, the geometric element 501 forms a T-shaped intersection if it consists of exactly two rectangular pieces in the configuration of FIG. 5A, where d₁, d₂≧eps, and d₃>2*eps, where eps is the overlay tolerance for the stepper that will be used to form structure during a lithographic process (i.e., the maximum distance that the two exposures can be offset from each other). Of course, still other embodiments of the invention may allow a user to specify the parameters for one or more of d₁, d₂, and d₃. Typically, this type of “T-intersection” configuration can be efficiently and unambiguously detected in the initial layout design data 315. Further, still other cut types, such as L-shaped intersections and π-shaped intersections (shown in FIGS. 5B and 5C, respectively), may alternately or additionally be employed. Also, as previously noted, any other desired technique, such as techniques employing process simulation, may alternately or additionally be used to determine suitable proposed cut paths.

With various examples of the invention, the identified potential cuts can be saved in a derived layer of layout design data. Each potential cut may be represented by, for example, a narrow polygon corresponding to the location of the identified potential cut. Of course, still other techniques for representing identified cuts may be employed according to various implementations of the invention.

Also, with various examples of the invention, the cut and separation directive instance identification unit 303 will typically identify all potential cuts that may be made in the initial layout design data 311. With still other implementations of the invention, however, the cut and separation directive instance identification unit 303 may only identify a subset of potential cuts that may be made in the layout design data 311. The subset may be selected based upon, for example, user-defined criteria.

Next, in step 405, the cut and separation directive instance identification unit 303 identifies instances of separation directives for the layout design data 311. As will be appreciated by those of ordinary skill in the art, a separation directive specification specifies when two geometric element edges should be assigned to different pattern sets for different masks. Thus, a typical separation directive specification may specify that two edges should be assigned to different pattern sets when the edges are closer than the resolution distance of the photolithographic process in which the masks are to be used. FIG. 6 illustrates an example of two geometric elements 601 and 603 that may be segmented. This figure also illustrates separation directive instances 605-613 that indicate which portions of the geometric elements 601 and 603 should be represented in separate masks. As seen in this figure, the cuts 615-619 divide the polygon 501 into polygon segments 501A-501D, while the cut 621 divides the polygon 503 into polygon segments 503A and 503B. As discussed above, with various examples of the invention, the cut and separation directive instance identification unit 303 may identify the separation directive instances 605-613.

The separation directive instances in a layout design may be identified based upon, for example, pre-defined separation directives. The separation directives may be specified by, for example, a user of the layout design data segmenting tool 301, a foundry that will manufacture a microdevice from the layout design data, a provider of the layout design data, or any other source. Also, it should be appreciated that identified separation directive instances may be represented in any convenient manner. For examples, some implementations of the invention may store identified separation directive instances as derived layout design data.

### Ordering of Potential Cuts and Separation Directive Instances

Next, in operation 407, the cut and separation directive instance ordering unit 305 orders both the separation directive instances for the design and the identified potential cuts. With some implementations of the invention, the separation directive instances and the identified potential cuts may be ordered in a single list. Moreover, various examples of the invention may order the separation directive instances and/or the identified potential cuts according to analysis values for the identified potential cuts and separation directive instances.

As previously noted, with conventional multiple-patterning techniques (e.g., double-patterning techniques), separation directive instances (like separation directive instances 605-613) may be identified from predefined separation directives. In some applications, the separation directive may also provide each of the separation directive instances with some type of analysis value, such as a weight value, indicating the relative importance of implementing that separation directive instance. For example, if a lithographic system has a resolution distance of 10 μm, then a separation directive specification may assign a separation directive instance of 10 μm (i.e., an instance where two edges are separated by a distance of 10 μm a weight of 0.1, indicating that it is not very important to implement this separation directive instance. On the other hand, it might assign separation directive instances of 5 μm and 1 μm weights of 0.5 and 1.0, respectively, indicating that it is more important to implement these separation directive instances. Similarly, potential cuts may be assigned analysis values, such as weight values, representing the importance of implementing the corresponding potential cut in the layout design. These analysis values, for both the identified potential cuts and the identified separation directive instances, may be obtained from any source, and the source or methodology for determining these analysis values are not relevant to various implementations of the invention.

As previously noted, with various implementations of the invention the cut and separation directive instance ordering unit 305 may order the separation directive instances and the identified potential cuts in a single list according to their analysis values. In some implementations of the invention, for example, the separation directives and identified cuts may be ordered from most desirable to least desirable based upon their corresponding analysis values. Of course, if one or more items do not have analysis values, then these items may be placed into the list in any desired position. With various implementations of the invention, for example, items without analysis values may be manually positioned in the list by a user. Still other implementations of the invention, however, may automatically position items without analysis values, such as at the beginning or end of the list.

### Selection and Implementation of Potential Cuts and Separation Directive Instances

Once the separation directive instances and identified potential cuts have been combined together into a single list, in operation 407 the cut and separation directive instance selection unit 307 will select both separation directive instances and identified potential cuts from the list for implementation in the layout design data. With some implementations of the invention, the cut and separation directive instance selection unit 307 will sequentially analyze each item in the list order, be it separation directive or identified cut, to determine if that item can be implemented in the design.

In some implementations of the invention, for example the cut and separation directive instance selection unit 307 may sequentially analyze each list item in order from the most desirable item to the least desirable item. The cut and separation directive instance selection unit 307 will then determine if the item being analyzed can be implemented in the complementary pattern sets for forming two complementary masks without creating a conflict. A conflict occurs where, for example, a first item would require a first edge to be formed by a different mask than a second edge, a second item would require that the second edge be formed by a different mask than a third edge, and a third item would require that the third edge be formed by a different mask than the first edge. All three items cannot be implemented using only two masks.

Various implementations of the invention may use a conflict graph to determine whether an item on the list (either a separation directive instance or an identified potential cut) can be implemented without creating a conflict. The conflict graph may have nodes that correspond to geometric elements and geometric element segments (that is, partitions of geometric elements that would occur if an identified potential cut or separation directive instance is implemented). The paths between two nodes would then correspond to the identified potential cut or separation directive instance that describes the relationship between the corresponding two geometric elements and geometric element segments. For example, if two adjacent nodes were geometric element segments, then the path between the two nodes would represent the identified potential cut that would create the two geometric elements segments.

If each cycle of the conflict graph is odd, then each node can be assigned one of two unique values or “colors” without adjacent nodes being assigned the same color. This means that each corresponding geometric element and geometric element segment represented by a node can be assigned to one of two complementary mask patterns without creating a conflict. If, however, one or more cycles of the conflict graph is even, then each node cannot be assigned one of two unique values or “colors” without adjacent nodes being assigned the same color, indicating that each corresponding geometric element and geometric element segment represented by a node cannot be assigned to one of two complementary mask patterns without creating a conflict.

Accordingly, with various embodiments of the invention, the cut and separation directive instance selection unit 307 will analyze a list item by trying to add the nodes and paths corresponding to that item to the conflict graph. If the addition of those nodes and paths create an even cycle in the conflict graph, then the item will be discarded from the list and the corresponding nodes and paths removed from the conflict graph. If it does not (i.e., the addition of those nodes and paths create only odd cycles in the conflict graph), then the item is maintained on the list and the corresponding nodes and paths are kept in the conflict graph.

It should be appreciated that various embodiments of the invention may employ various data processing shortcuts to minimize the time required to analyze each item on the list.

For example, some implementations of the invention may use a disjoint set methodology to analyze the list items. As will be appreciated by those of ordinary skill in the art, a disjoint set is a data structure that can be used to represent the relationship between nodes in a graph, such as a conflict graph. For example, if a conflict graph has nodes A, B, C, D, and E, the disjoint set can describe a relationship between each of nodes B, C, D and E relative to a representative node A. With various implementations of the invention, this relationship may be the similarity or difference between “colors” of the nodes. With this arrangement, if the cut and separation directive instance selection unit 307 will only add nodes and paths to conflict graph if it does not create a conflict. Accordingly, if the cut and separation directive instance selection unit 307 determines that adding any of the nodes and paths corresponding to an item would change the value of a previously established relationship in the disjoint set, it can quickly conclude that the added nodes and paths would create a conflict without having to walk through each cycle of the conflict graph to determine if any even cycles would be created.

In step 411, the cut and separation directive instance selection unit 307 implements the selected cuts and separation directive instances in the design. With some implementations of the invention, the cut and separation directive instance selection unit 307 may begin implementing a list item in the layout data as soon as a determination is made to implement the item. For still other implementations of the invention, however, the cut and separation directive instance selection unit 307 may wait until each of the list items have been analyzed before implementing the remaining items into the layout design. Because items in the list are analyzed in order of desirability, the most desirable items (whether separation directives or identified cuts) are analyzed first, reducing the likelihood that they will create a conflict in the layout design data. Then, in operation 411, the segmented layout data (i.e., the data incorporating the selected cut identification and separation directives) may be returned to the design data store 309.

### Conclusion

While specification embodiments of the invention have been shown and described in detail above to illustrate the principles of the invention, it will be understood that the invention may be otherwise embodied without departing from the invention. Thus, while the invention has been described with respect to specific examples, including presently preferred modes of carrying out the invention, those of ordinary skill in the art will appreciate that there are numerous variations and permutations of the above described systems and techniques that fall within the spirit and scope of the invention as described above.

What is claimed is:

1. A method of implementing separation directive instances or potential cuts in layout design data, comprising;
generating a list of separation directive instances and potential cuts occurring in layout design data;
sequentially analyzing each item in the list to determine if the item will create a conflict in complementary pattern sets for the layout design data; and
if the item will create a conflict in the complementary pattern sets, then discarding the item from the list.

2. The method recited in claim 1, further comprising implementing items from the list that will not create a conflict in complementary pattern sets into the layout design data.

3. The method recited in claim 1, wherein the items are ordered in the list according to corresponding analysis values.

4. The method recited in claim 1, wherein the items are ordered in the list from most desirable for implementation into the layout design data to least desirable for implementation into the layout design data.
